(19) United States
(12) Patent Application Publication
(10) Pub. No.: US 2008/0107413 A1
(43) Pub. Date: May 8, 2008

(54) Portable Camera Support

(75) Inventors: Darrin Moore, Preston, MD (US); John Buchanan, Preston, MD (US); Edward J. Kondracki, Great Falls, MD (US)

Correspondence Address: MILES & STOCKBRIDGE PC, 1751 PINNACLE DRIVE, SUITE 500, MCLEAN, VA, 22102-3833, US

(73) Assignee: Cross Winds Publishing, LLC, Preston, MD (US)

(21) Appl. No.: 11/556,310

(22) Filed: Nov. 3, 2006

(51) Int. Cl. G03B 17/00

(52) U.S. Cl. 396/428

(57) ABSTRACT

A portable camera support, combining a mounting bracket or tray with a shaft or pole and a foot bar, may provide stable, portable support for cameras or other devices. The stability of the support may yield more reliable scouting results. The portability of the support may afford greater efficiency, possibly resulting in reduced time associated with locating wildlife or other items of interest over a given area of coverage. An exemplary portable camera support may have a camera mounting bracket or tray releasibly mounted to a shaft. The shaft may be inserted, using the foot bar for example, into soil or other supportive media. The mounting bracket may then be adjusted vertically or rotationally with the aid of a set screw. The camera support may be configured with multiple mounting brackets releasibly mounted to a shaft, thereby providing up to a 360-degree field of view without adjusting the mounting brackets.

### BACKGROUND

The present invention relates generally to scouting via photographic or other means and, more particularly, to portable supports for cameras or other scouting devices.

Cameras and other sensing devices, such as motion sensors, are sometimes used to aid wildlife enthusiasts in scouting for wildlife and other items of interest. Providing a secure mounting platform for such devices can pose a challenge to the enthusiast. Tripod and monopod supports represent possible solutions but have the disadvantage that they lack stability in the outdoors. Such support structures are prone to being knocked over by the elements, such as wind, and wildlife. Another possible approach is to attach a scouting camera or other sensing device to a tree trunk. This mounting solution offers a greater degree of stability but carries the disadvantage that it lacks portability. Moving a camera or other sensing device from tree to tree can add a burdensome amount of set-up time to scouting activities and can further result in missed opportunities.

It is, therefore, desirable to provide a camera mounting solution that provides a significant degree of both stability and portability.

### SUMMARY

A portable camera support of the present invention combines a mounting bracket or tray with a shaft or pole and a foot bar, in a structure that provides a stable, portable support for cameras or other devices that may be used when scouting for wildlife or other items of interest. Various embodiments of the present invention may allow for easy vertical and rotational adjustment of the mounting bracket and the shaft, thereby affording numerous viewing positions for mounted scouting devices.

### BRIEF DESCRIPTION OF THE DRAWINGS

The accompanying drawings are incorporated in and constitute a part of the specification.

FIG. 1 shows a front perspective view of an embodiment of a portable camera support.

FIG. 2 shows a rear perspective view of an embodiment of a portable camera support shown in FIG. 1.

FIG. 3 shows a cross-sectional view of an embodiment of a portable camera support shown in FIG. 1, taken along line 3-3.

FIG. 4 shows a front perspective view of an embodiment of a portable camera support with a camera, for example, being mounted to the support.

FIG. 5 shows a perspective view of an embodiment of a portable camera support with a portion of the support being inserted into the ground, for example.

FIG. 6 shows a rear perspective view of an embodiment of a portable camera support with a camera, for example, being mounted to the support and a portion of the support being inserted into the ground, for example.

FIG. 7 shows a perspective view of another embodiment of a portable camera support with the support being configured with multiple mounting brackets or trays, for example.

FIG. 8 shows a front perspective view of another embodiment of a portable camera support.

FIG. 9 shows a cross-sectional view of an embodiment of a portable camera support shown in FIG. 8, taken along line 9-9.

FIG. 10 shows a rear perspective view of another embodiment of a portable camera support.

FIG. 11 shows a rear perspective view of another embodiment of a portable camera support.

FIG. 12 shows a front perspective view of another embodiment of a portable camera support.

FIG. 13 shows a rear perspective view of an embodiment of a portable camera support shown in FIG. 12.

FIG. 14 shows a front perspective view of another embodiment of a portable camera support.

FIG. 15 shows a rear perspective view of an embodiment of a portable camera support shown in FIG. 14.

FIG. 16 shows a rear perspective view of another embodiment of a portable camera support.

FIG. 17 shows a rear perspective view of another embodiment of a portable camera support.

### DETAILED DESCRIPTION

While the exemplary embodiments illustrated herein may show the various features of the present invention, it will be understood that the features disclosed herein may be combined variously to achieve the objectives of the present invention.

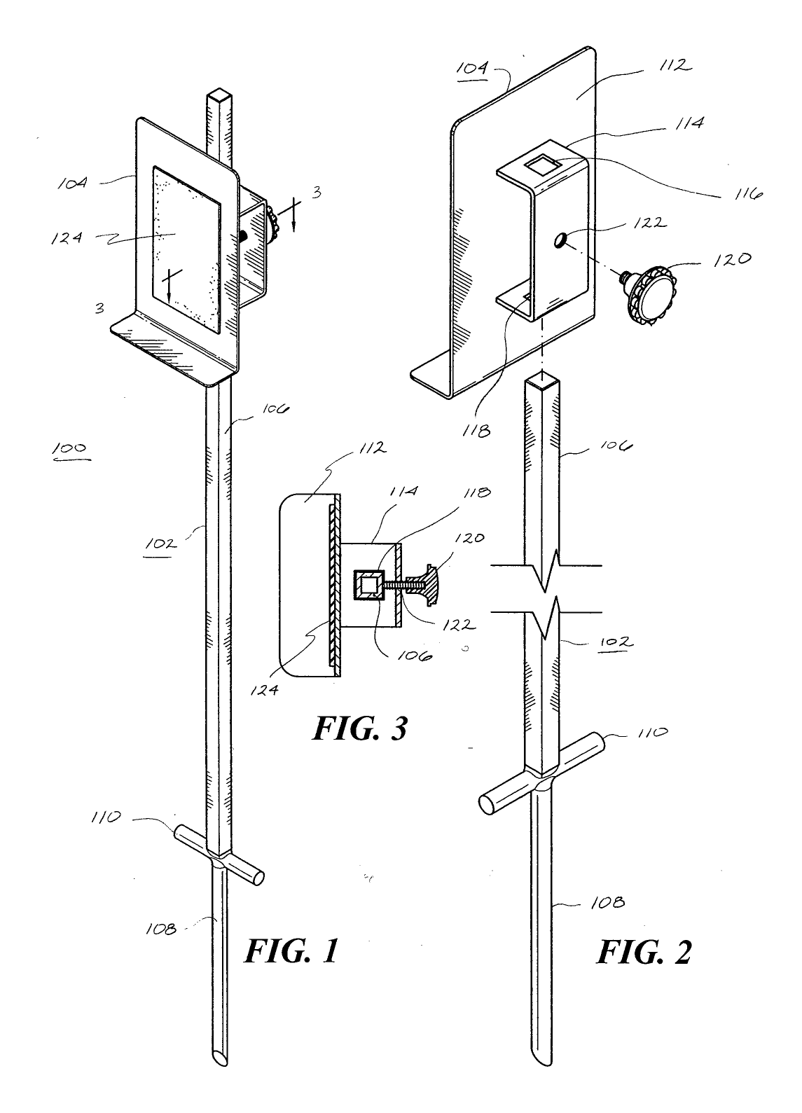

Turning to FIG. 1, an exemplary embodiment of a portable camera support [100] is shown with a shaft or pole [102] and a mounting bracket or tray [104] releasibly mounted to the shaft or pole.

The shaft or pole [102] portion of the camera support [100] as shown in FIG. 1 includes an upper rectangular portion [106] and a lower cylindrical portion [108]. The upper and lower portions of the shaft or pole are coaxial and meet at a cylindrical foot bar [110]. The foot bar is integrally attached to the shaft or pole by welding, for example, or by other suitable means, and is oriented substantially perpendicular to the axis of the shaft or pole. The shaft or pole [102] may be a hollow tubular member, as shown in FIG. 3, or may be a solid member. The shaft or pole may be made of steel, or other suitable materials such as aluminum or plastic.

The mounting bracket [104] portion of the camera support [100] as shown in FIGS. 1, 2 and 3 includes a face plate [112], a collar [114], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The face plate [112] may include a pad [124] affixed to one or both of the planar faces. Such a pad may afford more secure mounting and greater protection for a camera or other sensing device. The collar [114] is a channel-shaped member and includes at least three substantially planar surfaces—one vertical web and two horizontal flanges—the two horizontal flanges having coaxial holes [116, 118] of suitable size and shape to accommodate the upper portion [106] of the shaft or pole [102]. The collar may be integrally attached to a rear side of the face plate [112] by welding, for example, or by other suitable means, and is oriented such that the axis of the coaxial holes [116, 118] in the flanges is substantially parallel to a vertical edge of the face plate [112]. The face plate and collar may be made of steel, or other suitable materials such as aluminum or plastic.

FIG. 3 shows a cross-sectional view of the camera support [100] taken along line 3-3 of FIG. 1. In this embodiment, the mounting bracket or tray [104] is releasibly mounted on the shaft or pole [102]. The upper portion [106] of the shaft or pole is inserted through coaxial holes [116, 118] in the collar [114] and held in place by frictional contact between the set screw [120] and the upper portion [106] of the shaft or pole. The degree of frictional contact may be adjusted by loosening or tightening the set screw [120] through a threaded hole [122] in the collar [114].

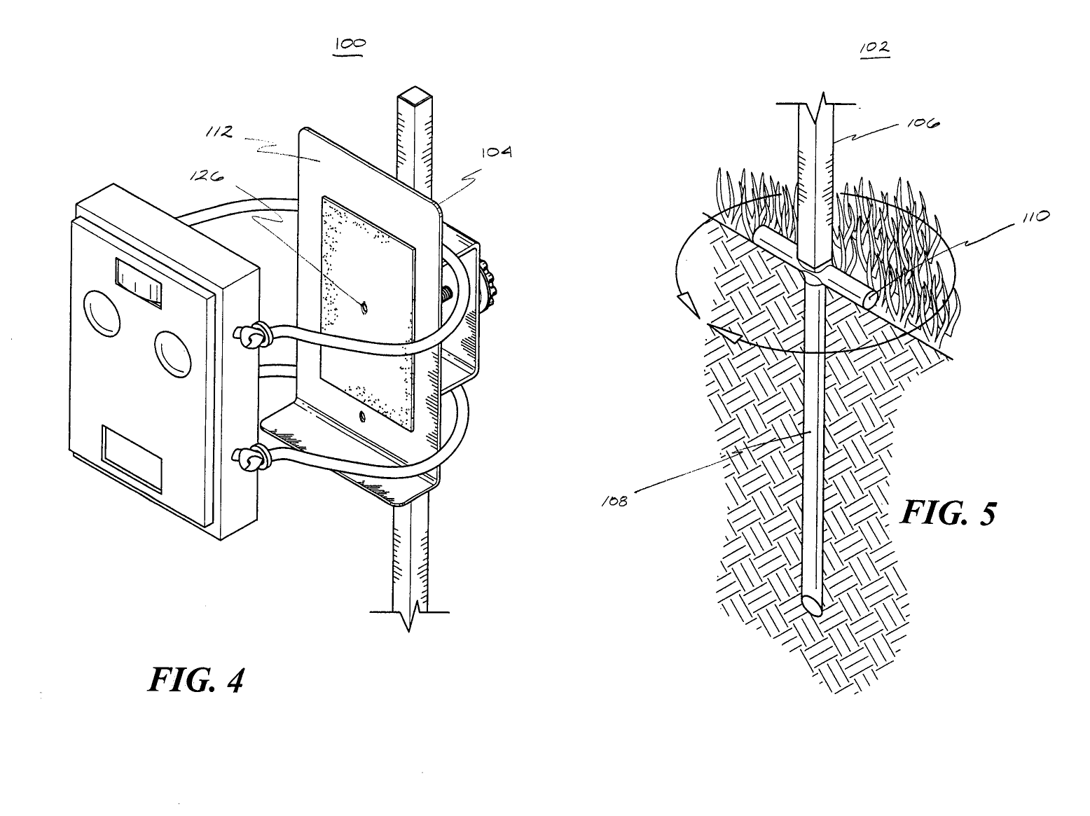

FIG. 4 shows a front perspective view of an embodiment of a portable camera support [100] with a camera, for example, being mounted to the support. In this embodiment, a device such as a scouting camera or motion sensor may be mounted on the support by securing the device to the mounting bracket [104] using straps or other suitable means. One or more holes [126], for instance, may be included in the face plate [112] of the mounting bracket [104] to aid in securing a device to the bracket. The camera, or other device, may also be supported by a shelf-like or seat-like structure on the front side of the mounting bracket [104].

FIG. 5 shows a perspective view of an embodiment of a portable camera support with a portion of the support being inserted into the ground, for example. In this embodiment, the lower cylindrical portion [108] of the shaft or pole [102] portion of the camera support is inserted into the ground, for example, until the cylindrical foot bar [110] meets the ground surface. The foot bar [110] may be used to aid in setting up the portable camera support. A user could place the portable camera support with the lower portion [108] of the shaft [102] pointed downward at a desired location on the ground and then press down on the foot bar using their foot, for example, thereby driving the lower portion [108] of the shaft [102] into the ground. The foot bar may also provide the camera support with a greater degree of lateral stability when the support is installed in the ground, for example. Once in the ground, the lower cylindrical portion of the shaft or pole may allow for 360-degree positioning of the portable camera support with minimum effort and without disturbing a mounted camera or other device. In this embodiment, the upper rectangular portion [106] of the shaft or pole [102] remains above the ground surface.

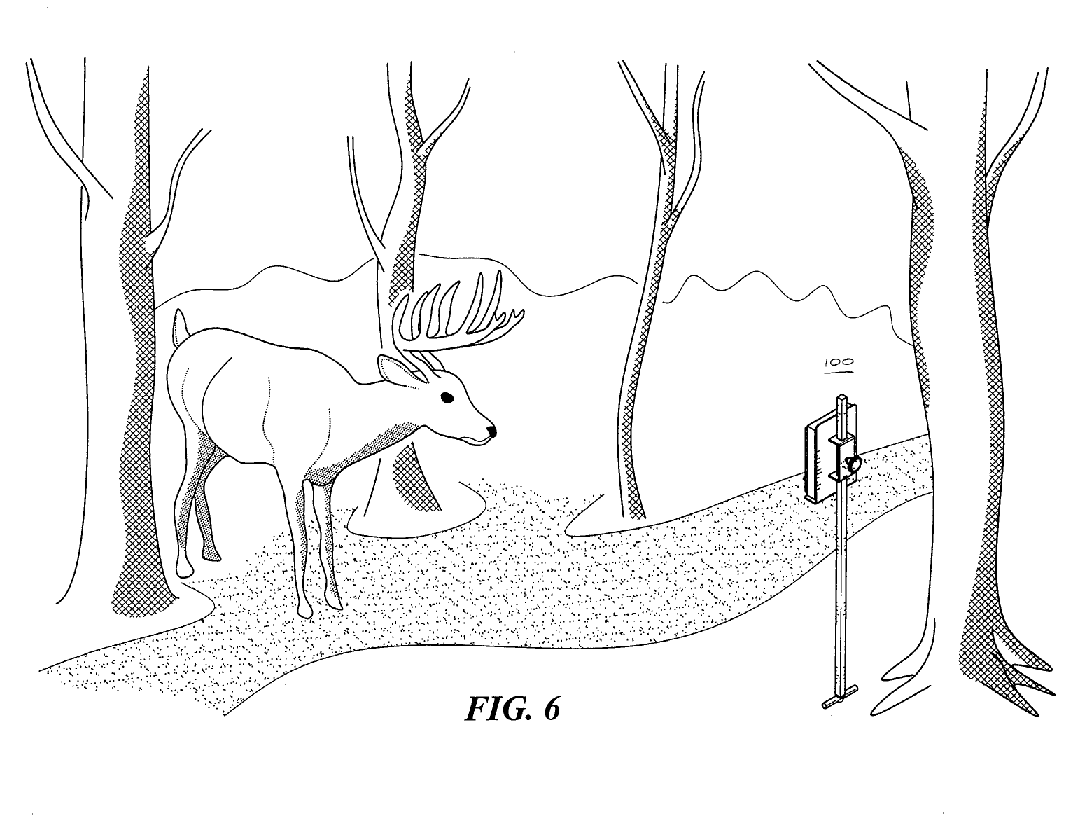

FIG. 6 shows a rear perspective view of an embodiment of a portable camera support with a camera or other sensing device, for example, being mounted to the support and a portion of the support being inserted into the ground, for example. In this embodiment, the portable camera support [100] is being used to aid in scouting for deer or other wildlife or items of interest.

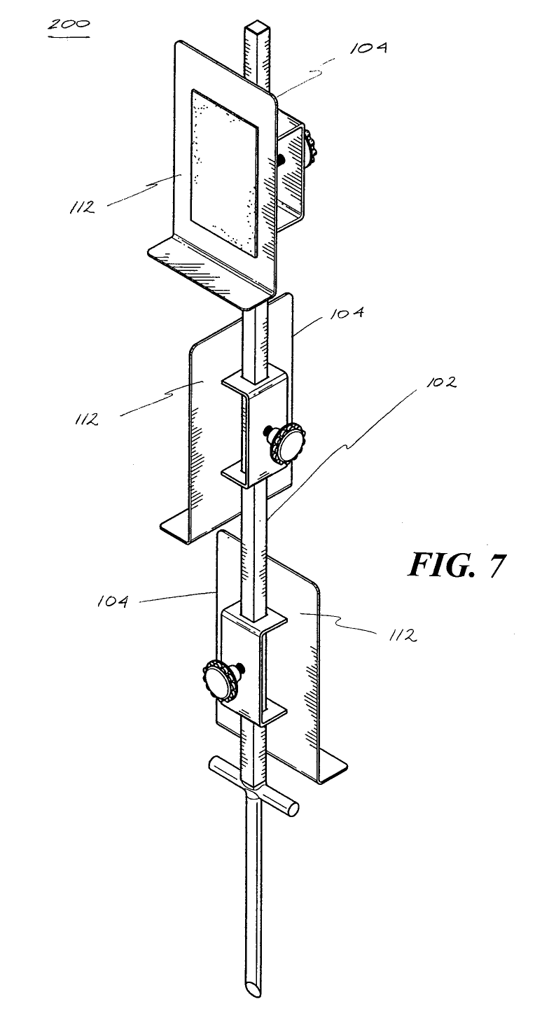

FIG. 7 shows a perspective view of another embodiment of a portable camera support [200] with the support being configured with multiple mounting brackets or trays [104]. In this embodiment, the mounting brackets are releasibly mounted on the pole or shaft [102] such that the vertical faces of the face plate [112] portions of the mounting brackets are oriented at substantially right angles to each other. This allows for multiple cameras, or other devices, to be mounted to the portable camera support [200] and may thereby allow for up to a 360-degree field of view when scouting for wildlife or other items of interest, without having to make additional adjustments to the support following initial set-up.

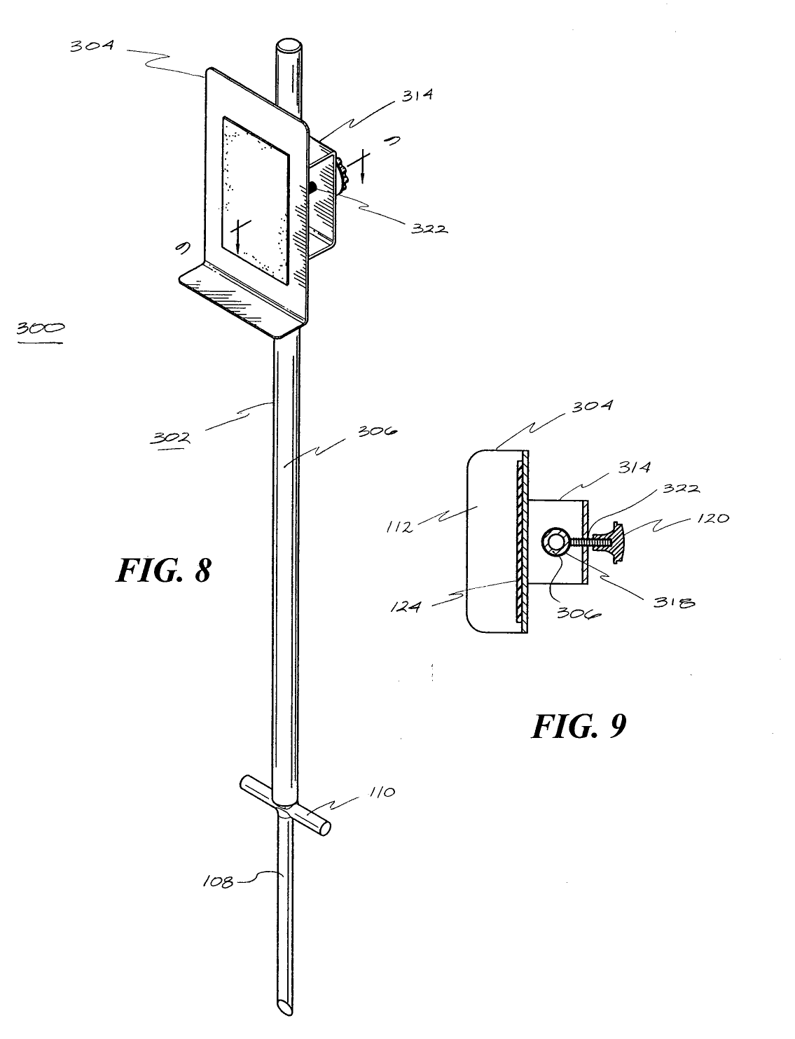

FIG. 8 shows a front perspective view of yet another embodiment of a portable camera support [300]. The shaft or pole [302] portion of the camera support [300] as shown in FIG. 8 includes an upper cylindrical portion [306] and a lower cylindrical portion [108]. The upper and lower portions of the shaft or pole are coaxial and meet at a cylindrical foot bar [110]. The foot bar is integrally attached to the shaft or pole by welding, for example, or by other suitable means, and is oriented substantially perpendicular to the axis of the shaft or pole. The shaft or pole [302] may be a hollow tubular member, as shown in FIG. 9, or may be a solid member. The shaft or pole may be made of steel, or other suitable materials such as aluminum or plastic.

The mounting bracket [304] portion of the camera support [300] as shown in FIGS. 8 and 9 includes a face plate [112], a collar [314], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The face plate [112] may include a pad [124] affixed to one or both of the planar faces. Such a pad may afford more secure mounting and greater protection for a camera or other sensing device. The collar [314] is a channel-shaped member and includes at least three substantially planar surfaces—one vertical web and two horizontal flanges—the two horizontal flanges having coaxial holes [316, 318] of suitable size and shape to accommodate the upper portion [306] of the shaft or pole [302]. The collar may be integrally attached to a rear side of the face plate [112] by welding, for example, or by other suitable means, and is oriented such that the axis of the coaxial holes [316, 318] in the flanges is substantially parallel to a vertical edge of the face plate [112]. The face plate and collar may be made of steel, or other suitable materials such as aluminum or plastic.

FIG. 9 shows a cross-sectional view of the camera support [300] taken along line 9-9 of FIG. 8. In this embodiment, the mounting bracket or tray [304] is releasibly mounted on the shaft or pole [302]. The upper portion [306] of the shaft or pole is inserted through coaxial holes [316, 318] in the collar [314] and held in place by frictional contact between the set screw [120] and the upper portion [306] of the shaft or pole. The degree of frictional contact may be adjusted by loosening or tightening the set screw [120] through a threaded hole [322] in the collar [314]. The cylindrical cross-section of the upper portion [306] of the shaft or pole [302] may allow the mounting bracket [304] to be rotationally adjusted about the shaft within a 360-degree range. This may be important in alleviating situations where the portable camera support has been installed in ground soil that is packed tight or has become frozen, making the shaft difficult to rotate.

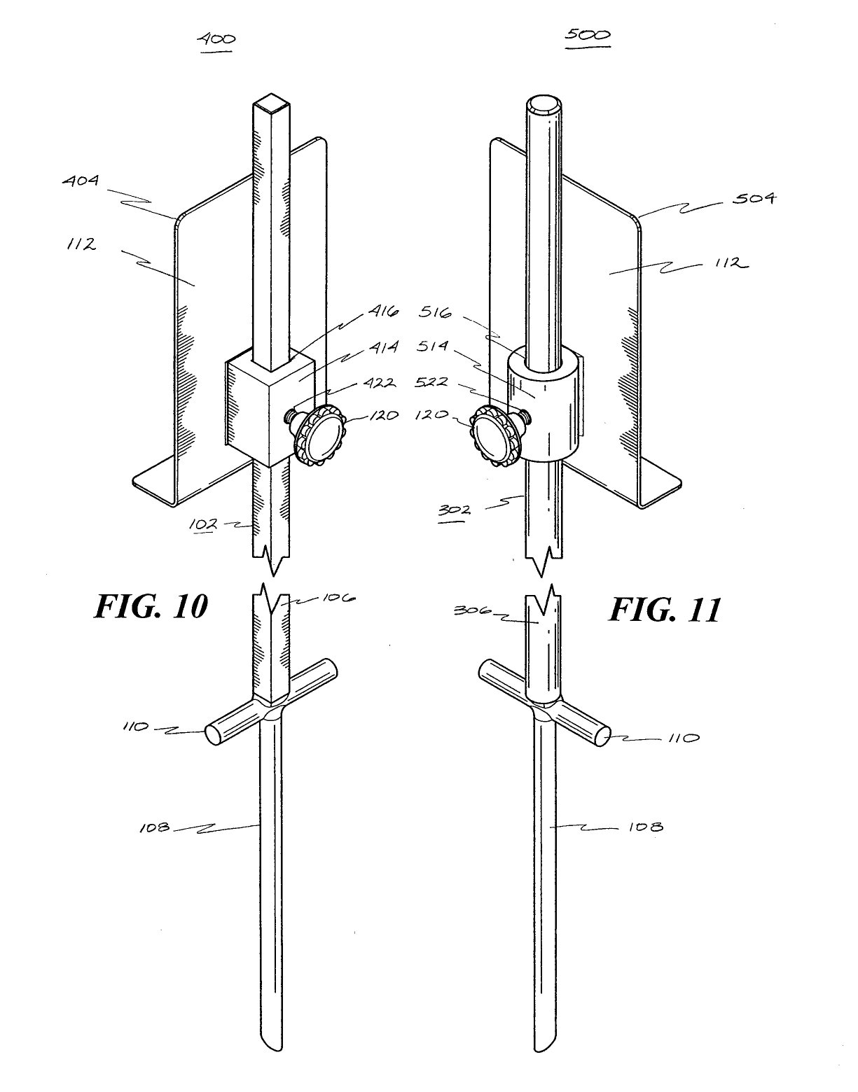

FIG. 10 shows a rear perspective view of yet another embodiment of a portable camera support [400]. The shaft or pole [102] portion of the camera support [400] as shown in FIG. 10 includes an upper rectangular portion [106] and a lower cylindrical portion [108]. The upper and lower portions of the shaft or pole are coaxial and meet at a cylindrical foot bar [110]. The foot bar is integrally attached to the shaft or pole by welding, for example, or by other suitable means, and is oriented substantially perpendicular to the axis of the shaft or pole. The shaft or pole [102] may be a hollow tubular member or may be a solid member. The shaft or pole may be made of steel, or other suitable materials such as aluminum or plastic.

The mounting bracket [404] portion of the camera support [400] as shown in FIG. 10 includes a face plate [112], a collar [414], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The collar [414] is a rectangular block-shaped member having a bore [416] of suitable size and shape to accommodate the upper portion [106] of the shaft or pole [102]. The collar may be integrally attached to a rear side of the face plate [112] by welding, for example, or by other suitable means, and is oriented such that the axis of the bore [416] in the collar is substantially parallel to a vertical edge of the face plate [112]. The face plate and collar may be made of steel, or other suitable materials such as aluminum or plastic.

In the embodiment shown in FIG. 10, the mounting bracket or tray [404] is releasibly mounted on the shaft or pole [102]. The upper portion [106] of the shaft or pole is inserted through bore [416] in the collar [414] and held in place by frictional contact between the set screw [120] and the upper portion [106] of the shaft or pole. The degree of frictional contact may be adjusted by loosening or tightening the set screw [120] through a threaded hole [422] in the collar [414].

FIG. 11 shows a rear perspective view of yet another embodiment of a portable camera support [500]. The shaft or pole [302] portion of the camera support [500] as shown in FIG. 11 includes an upper cylindrical portion [306] and a lower cylindrical portion [108]. The upper and lower portions of the shaft or pole are coaxial and meet at a cylindrical foot bar [110]. The foot bar is integrally attached to the shaft or pole by welding, for example, or by other suitable means, and is oriented substantially perpendicular to the axis of the shaft or pole. The shaft or pole [302] may be a hollow tubular member or may be a solid member. The shaft or pole may be made of steel, or other suitable materials such as aluminum or plastic.

The mounting bracket [504] portion of the camera support [500] as shown in FIG. 11 includes a face plate [112], a collar [514], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The collar [514] is a cylindrical block-shaped member having a bore [516] of suitable size and shape to accommodate the upper portion [306] of the shaft or pole [302]. The collar may be integrally attached to a rear side of the face plate [112] by welding, for example, or by other suitable means, and is oriented such that the axis of the bore [516] in the collar is substantially parallel to a vertical edge of the face plate [112]. The face plate and collar may be made of steel, or other suitable materials such as aluminum or plastic.

In the embodiment shown in FIG. 11, the mounting bracket or tray [504] is releasibly mounted on the shaft or pole [302]. The upper portion [306] of the shaft or pole is inserted through bore [516] in the collar [514] and held in place by frictional contact between the set screw [120] and the upper portion [306] of the shaft or pole. The degree of frictional contact may be adjusted by loosening or tightening the set screw [120] through a threaded hole [522] in the collar [514].

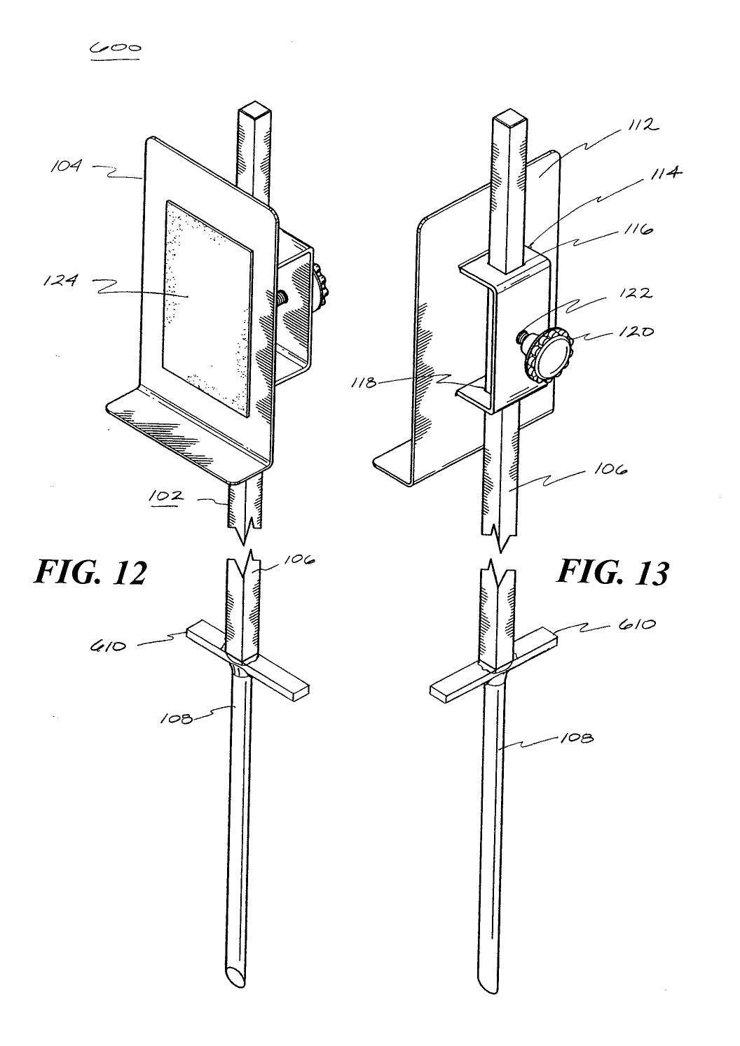

FIG. 12 shows a front perspective view of another embodiment of a portable camera support [600]. The shaft or pole [102] portion of the camera support [600] as shown in FIG. 12 includes an upper rectangular portion [106] and a lower cylindrical portion [108]. The upper and lower portions of the shaft or pole are coaxial and meet at a rectangular foot bar [610]. The foot bar is integrally attached to the shaft or pole by welding, for example, or by other suitable means, and is oriented substantially perpendicular to the axis of the shaft or pole. The shaft or pole [102] may be a hollow tubular member or may be a solid member. The shaft or pole may be made of steel, or other suitable materials such as aluminum or plastic. The rectangular foot bar [610], as compared to a cylindrical foot bar, may provide a broader surface upon which a user may rest their foot, for example, when pressing down on the foot bar to drive the lower portion [108] of the shaft [102] into the ground. The rectangular foot bar, as compared to the cylindrical foot bar, may also provide the camera support [600] with an even greater degree of lateral stability when the support is installed in the ground, for example.

The mounting bracket [104] portion of the camera support [600] as shown in FIGS. 12 and 13 include a face plate [112], a collar [114], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The face plate [112] may include a pad [124] affixed to one or both of the planar faces. Such a pad may afford more secure mounting and greater protection for a camera or other sensing device. The collar [114] is a channel-shaped member and includes at least three substantially planar surfaces—one vertical web and two horizontal flanges—the two horizontal flanges having coaxial holes [116, 118] of suitable size and shape to accommodate the upper portion [106] of the shaft or pole [102]. The collar may be integrally attached to a rear side of the face plate [112] by welding, for example, or by other suitable means, and is oriented such that the axis of the coaxial holes [116, 118] in the flanges is substantially parallel to a vertical edge of the face plate [112]. The face plate and collar may be made of steel, or other suitable materials such as aluminum or plastic.

In the embodiment shown in FIG. 13, the mounting bracket or tray [104] is releasibly mounted on the shaft or pole [102]. The upper portion [106] of the shaft or pole is inserted through the holes [116, 118] in the collar [114] and held in place by frictional contact between the set screw [120] and the upper portion [106] of the shaft or pole. The degree of frictional contact may be adjusted by loosening or tightening the set screw [120] through a threaded hole [122] in the collar [114].

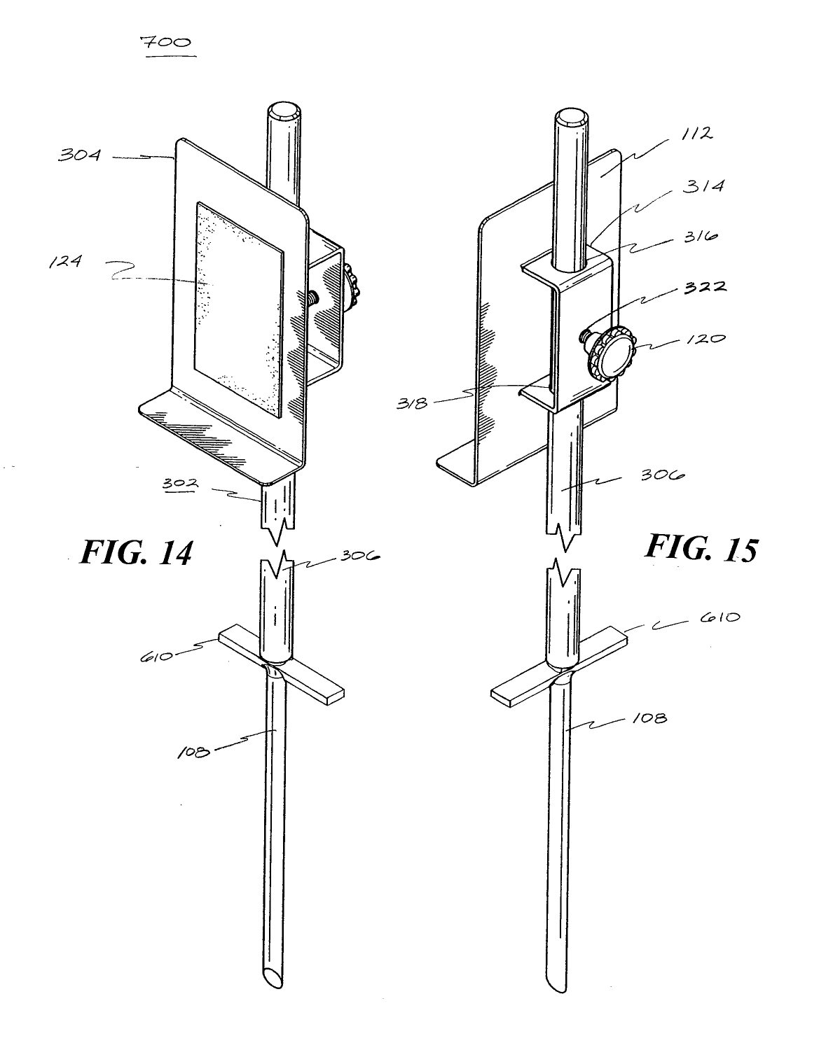

FIG. 14 shows a front perspective view of yet another embodiment of a portable camera support [700]. The shaft or pole [302] portion of the camera support [700] as shown in FIG. 14 includes an upper cylindrical portion [306] and a lower cylindrical portion [108]. The upper and lower portions of the shaft or pole are coaxial and meet at a rectangular foot bar [610]. The foot bar is integrally attached to the shaft or pole by welding, for example, or by other suitable means, and is oriented substantially perpendicular to the axis of the shaft or pole. The shaft or pole [302] may be a hollow tubular member or may be a solid member. The shaft or pole may be made of steel, or other suitable materials such as aluminum or plastic.

The mounting bracket [304] portion of the camera support [700] as shown in FIGS. 14 and 15 includes a face plate [112], a collar [314], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The face plate [112] may include a pad [124] affixed to one or both of the planar faces. Such a pad may afford more secure mounting and greater protection for a camera or other sensing device. The collar [314] is a channel-shaped member and includes at least three substantially planar surfaces—one vertical web and two horizontal flanges—the two horizontal flanges having coaxial holes [316, 318] of suitable size and shape to accommodate the upper portion [306] of the shaft or pole [302]. The collar may be integrally attached to a rear side of the face plate [112] by welding, for example, or by other suitable means, and is oriented such that the axis of the coaxial holes [316, 318] in the flanges is substantially parallel to a vertical edge of the face plate [112]. The face plate and collar may be made of steel, or other suitable materials such as aluminum or plastic.

In the embodiment shown in FIG. 15, the mounting bracket or tray [304] is releasibly mounted on the shaft or pole [302]. The upper portion [306] of the shaft or pole is inserted through the holes [316, 318] in the collar [314] and held in place by frictional contact between the set screw [120] and the upper portion [306] of the shaft or pole. The degree of frictional contact may be adjusted by loosening or tightening the set screw [120] through a threaded hole [322] in the collar [314].

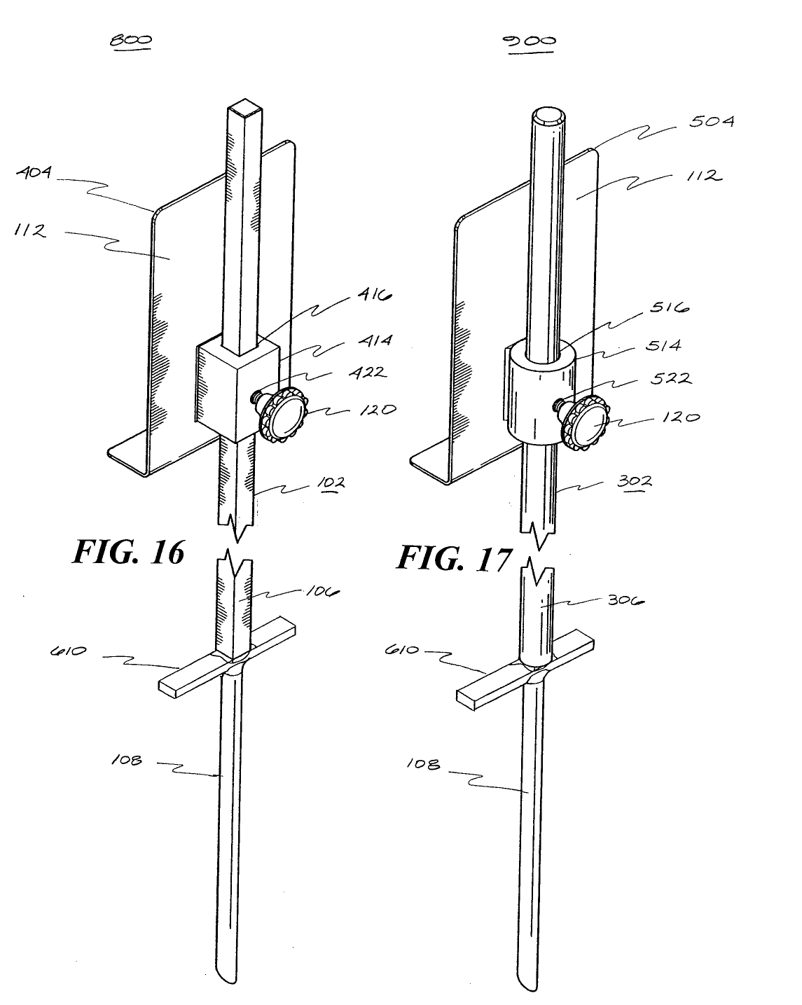

FIG. 16 shows a rear perspective view of yet another embodiment of a portable camera support [800]. The shaft or pole [102] portion of the camera support [800] as shown in FIG. 16 includes an upper rectangular portion [106] and a lower cylindrical portion [108]. The upper and lower portions of the shaft or pole are coaxial and meet at a rectangular foot bar [610]. The foot bar is integrally attached to the shaft or pole by welding, for example, or by other suitable means, and is oriented substantially perpendicular to the axis of the shaft or pole. The shaft or pole [102] may be a hollow tubular member or may be a solid member. The shaft or pole may be made of steel, or other suitable materials such as aluminum or plastic.

The mounting bracket [404] portion of the camera support [800] as shown in FIG. 16 includes a face plate [112], a collar [414], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The collar [414] is a rectangular block-shaped member having a bore [416] of suitable size and shape to accommodate the upper portion [106] of the shaft or pole [102]. The collar may be integrally attached to a rear side of the face plate [112] by welding, for example, or by other suitable means, and is oriented such that the axis of the bore [416] in the collar is substantially parallel to a vertical edge of the face plate [112]. The face plate and collar may be made of steel, or other suitable materials such as aluminum or plastic.

In the embodiment shown in FIG. 16, the mounting bracket or tray [404] is releasibly mounted on the shaft or pole [102]. The upper portion [106] of the shaft or pole is inserted through bore [416] in the collar [414] and held in place by frictional contact between the set screw [120] and the upper portion [106] of the shaft or pole. The degree of frictional contact may be adjusted by loosening or tightening the set screw [120] through a threaded hole [422] in the collar [414].

FIG. 17 shows a rear perspective view of yet another embodiment of a portable camera support [900]. The shaft or pole [302] portion of the camera support [900] as shown in FIG. 17 includes an upper cylindrical portion [306] and a lower cylindrical portion [108]. The upper and lower portions of the shaft or pole are coaxial and meet at a rectangular foot bar [610]. The foot bar is integrally attached to the shaft or pole by welding, for example, or by other suitable means, and is oriented substantially perpendicular to the axis of the shaft or pole. The shaft or pole [302] may be a hollow tubular member or may be a solid member. The shaft or pole may be made of steel, or other suitable materials such as aluminum or plastic.

The mounting bracket [504] portion of the camera support [500] as shown in FIG. 17 includes a face plate [112], a collar [514], and a set screw [120]. The face plate [112] is a substantially rectangular angle-shaped member having at least two substantially planar faces—one vertical web and one horizontal flange—oriented substantially perpendicular to each other, thereby forming a shelf-like or seat-like structure on a front side for supporting a camera or other similar device. The collar [514] is a cylindrical block-shaped member having a bore [516] of suitable size and shape to accommodate the upper portion [306] of the shaft or pole [302]. The collar may be integrally attached to a rear side of the face plate [112] by welding, for example, or by other suitable means, and is oriented such that the axis of the bore [516] in the collar is substantially parallel to a vertical edge of the face plate [112]. The face plate and collar may be made of steel, or other suitable materials such as aluminum or plastic.

In the embodiment shown in FIG. 17, the mounting bracket or tray [504] is releasibly mounted on the shaft or pole [302]. The upper portion [306] of the shaft or pole is inserted through bore [516] in the collar [514] and held in place by frictional contact between the set screw [120] and the upper portion [306] of the shaft or pole. The degree of frictional contact may be adjusted by loosening or tightening the set screw [120] through a threaded hole [522] in the collar [514].

Any of the above features could be combined into an embodiment of a portable camera support.

It is, therefore, apparent that there is provided in accordance with the present invention, a structure for supporting a camera, or other sensing device, in a portable manner. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A portable camera support comprising:
a shaft, comprising an upper portion and a lower portion, the upper and lower portion being joined at a foot bar, wherein the foot bar is substantially perpendicular to an axis of the shaft; and
at least one mounting bracket, comprising:
a face plate, comprising a substantially rectangular angle-shaped member having at least two substantially planar faces oriented substantially perpendicular to each other, thereby forming a shelf-like structure on a front side of the face plate;
a collar, comprising at least three surfaces, one substantially vertical and two substantially horizontal, each of the two horizontal surfaces having a coaxial hole of suitable size and shape to accommodate the upper portion of the shaft, wherein
the collar is integrally attached to a rear side of the face plate,
the collar is oriented such that an axis of the coaxial holes in the two horizontal surfaces is substantially parallel to a vertical edge of the face plate, and
the vertical surface of the collar contains a threaded hole aligned with the axis of the coaxial holes; and
a set screw of suitable size and thread pitch to engage the threaded hole in the vertical surface of the collar, wherein
the mounting bracket is releasibly mounted on the shaft through engagement of the upper portion of the shaft with the coaxial holes in the collar and through engagement of the set screw with the upper portion of the shaft.

2. The portable camera support of claim 1, wherein the upper and lower portions of the shaft are substantially coaxial.

3. The portable camera support of claim 1, wherein the upper and lower portions of the shaft comprise a hollow tubular member.

4. The portable camera support of claim 1, wherein the upper and lower portions of the shaft comprise a solid tubular member.

5. The portable camera support of claim 1, wherein the lower portion of the shaft is substantially cylindrical in cross section.

6. The portable camera support of claim 5, wherein the upper portion of the shaft is substantially rectangular in cross section.

7. The portable camera support of claim 5, wherein the upper portion of the shaft is substantially cylindrical in cross section.

8. The portable camera support of claim 1, wherein the foot bar is integrally attached to the shaft.

9. The portable camera support of claim 8, wherein the foot bar is integrally attached to the shaft by welding.

10. The portable camera support of claim 1, wherein the collar is integrally attached to the rear side of the face plate by welding.

11. The portable camera support of claim 1, wherein the face plate contains one or more holes to aid in securing a device to the mounting bracket.

12. The portable camera support of claim 1, wherein at least two mounting brackets are releasibly mounted on the shaft through engagement of the upper portion of the shaft with the coaxial holes in each of the collars and through engagement of each of the set screws with the upper portion of the shaft.

13. The portable camera support of claim 12, wherein at least two of the mounting brackets are releasibly mounted on the shaft such that the vertical faces of the face plate portions of the mounting brackets are oriented at substantially 90-degree angles to each other.

14. The portable camera support of claim 1, wherein the collar comprises a channel-shaped member and includes at least three substantially planar surfaces, one vertical and two horizontal, each of the two horizontal surfaces having a coaxial hole of suitable size and shape to accommodate the upper portion of the shaft.

15. The portable camera support of claim 1, wherein the collar comprises a rectangular block-shaped member having a bore of suitable size and shape to accommodate the upper portion of the shaft.

16. The portable camera support of claim 1, wherein the collar comprises a cylindrical block-shaped member having a bore of suitable size and shape to accommodate the upper portion of the shaft.

17. The portable camera support of claim 1, wherein the foot bar is substantially cylindrical in cross section.

18. The portable camera support of claim 1, wherein the foot bar is substantially rectangular in cross section.

19. The portable camera support of claim 1, wherein the face plate includes a pad affixed to one or more of the planar faces.
